(19) United States
(12) Patent Application Publication
(10) Pub. No.: US 2008/0049693 A1
(43) Pub. Date: Feb. 28, 2008

(54) Method and apparatus for facilitating a conveyance of informational content using wireless addresses

(75) Inventor: John M. Harris, Chicago, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/467,402

(22) Filed: Aug. 25, 2006

(51) Int. Cl. H04Q 7/24

(52) U.S. Cl. 370/338

(57) ABSTRACT

A plurality of wireless addresses to be transmitted using a shared message and at least one item of informational content are provided (101 and 102). At least some of the plurality of wireless address are then arranged (103) into an order that represents the at least one item of informational content. Upon transmitting (104) a shared message that contains this content, a receiving platform can, in turn, decode (302) (and hence recover) the at least one item of informational content as a function, at least in part, of that aforementioned particular order.

### TECHNICAL FIELD

This invention relates generally to wireless communications and more particularly to the transmission of wireless addresses.

### BACKGROUND

One-way and two-way wireless communications platforms of various kinds are known in the art. Many such platforms have one or more corresponding wireless addresses. Such a wireless address can serve, for example, to indicate that a particular message is intended for receipt and processing by only a given corresponding wireless platform.

The prior art also contemplates transmitting a shared message to a group of recipients. By one approach, this can comprise transmitting a plurality of wireless addresses in a shared message. Upon receipt, a given wireless receiver compares the plurality of wireless addresses against its own wireless address. A match confirms for the wireless receiver that the shared message is intended for that given wireless receiver (amongst others who are also so identified).

Despite various ongoing improvements, wireless bandwidth typically comprises a valuable resource. In some systems, such shared messages may be sent on a relatively frequent basis. Furthermore, each such shared message may comprise a relatively large number of wireless addresses to facilitate reaching a corresponding relatively large number of wireless receivers. As a result, considerable bandwidth becomes dedicated to supporting such traffic and content. Such usage, in turn, usurps this bandwidth and renders it unavailable to support other kinds of traffic. This can lead to congestion, data throughput delays, errant transmissions, and so forth.

### BRIEF DESCRIPTION OF THE DRAWINGS

The above needs are at least partially met through provision of the method and apparatus for facilitating a conveyance of informational content using wireless addresses described in the following detailed description, particularly when studied in conjunction with the drawings, wherein:

FIG. 1 comprises a flow diagram as configured in accordance with various embodiments of the invention;

FIG. 2 comprises a schematic view of a shared message as configured in accordance with various embodiments of the invention;

FIG. 3 comprises a flow diagram as configured in accordance with various embodiments of the invention; and

FIG. 4 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a plurality of wireless addresses to be transmitted using a shared message and at least one item of informational content are provided. At least some of the plurality of wireless address are then arranged into an order that represents the at least one item of informational content. Upon transmitting a shared message that contains this content, a receiving platform can, in turn, decode (and hence recover) the at least one item of informational content as a function, at least in part, of that aforementioned particular order.

By one approach, this at least one item of informational content can itself comprise one or more of the wireless addresses to be transmitted using the shared message. Alternatively, in the case where each address being explicitly transmitted represents an incomplete or partial address, (e.g. the most significant bits of that address or a hashed version of that address) this additional informational content may convey additional less significant bits to be appended to at least some of the explicitly signaled addresses. So configured, the overall number of bits required to represent these wireless addresses, in the aggregate, can often be reduced (and sometimes considerably) as compared to prior art practice in this regard.

This, in turn, can lead to reduced needs with respect to system bandwidth and thereby render that freed up bandwidth to be used for other purposes. This can lead to improved throughput for other payloads and content, improved overall system efficiency, and so forth. Those skilled in the art will understand that these teachings offer a highly flexible approach that can be implemented in any of a variety of ways. Those skilled in the art will also recognize and appreciate that these teachings are highly scalable, with bandwidth savings opportunities actually increasing in many cases as the number of wireless addresses to be conveyed grows.

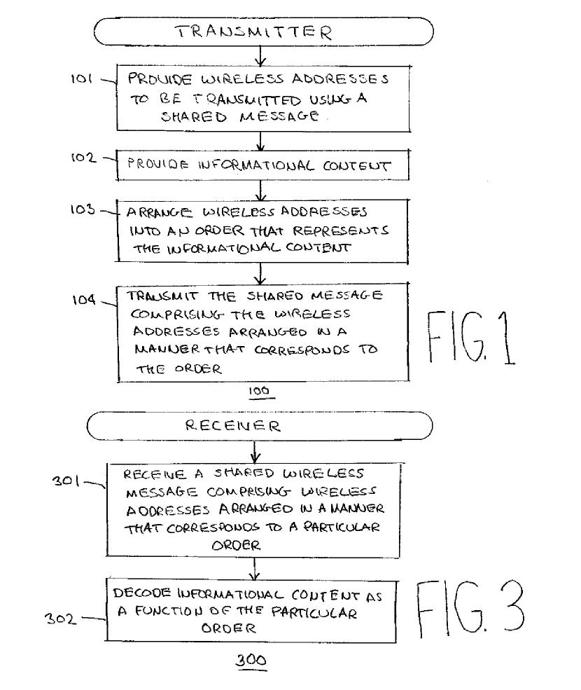

These and other benefits may become clearer upon making a thorough review and study of the following detailed description. Referring now to the drawings, and in particular to FIG. 1, an illustrative process 100 to be implemented, for example, by a transmission platform provides 101 a plurality of wireless addresses to be transmitted using a shared message. These might comprise, for example, wireless addresses as correspond to each of a corresponding plurality of cellular telephones that are to be paged via the shared message.

As noted above and as will be described below in more detail, additional information can be conveyed via a particular arrangement of these wireless addresses. In such a case, if desired, this shared message can also further optionally comprise an indicator to convey to the receiver that such informational content is, indeed, substantively including in the shared message. With momentary reference to FIG. 2, such a shared message 200 can therefore comprise both the aforementioned wireless addresses 201 and such an indicator 202. By one approach, this indicator 202 can comprise a one bit field where, for example, a value of “0” can represent that the wireless address arrangement does not correspond to any additional informational content and where a value of “1” can represent that the wireless address arrangement does, in fact, contain such additional informational content as described herein.

Referring again to FIG. 1, this process 100 can further provide 102 at least one item of informational content. In a typical application setting, this informational content will comprise content that is intended for at least one of the wireless receivers as corresponds to at least one of the aforementioned wireless addresses. By one approach, this informational content can itself comprise one or more of the plurality of wireless addresses though other possibilities exist. If desired, this informational content can comprise essentially any user and/or system-related content including executable instructions, operational code, data, and so forth.

As noted, this informational content will often be intended for at least one of the wireless receivers as corresponds to at least one of the wireless addresses. In such a case, if desired, the particular informational content selected can be chosen in a manner calculated to promote and/or avoid promoting particular behaviors and/or conditions at various ones of the wireless receivers. As but one illustration in this regard, when it is known that a given one of the wireless receivers presently has relatively low power reserves while another of the wireless receivers presently has a relatively deep power reserve, the informational content may be chosen to comprise content that is intended for the wireless receiver having the deeper power reserves while avoiding the wireless receiver experiencing the more depleted state. By this approach, the power-consumptive actions described herein as will be effected by the wireless receiver that processes the wireless addresses in order to decode the informational content will be directed to a receiving platform that is likely better able to effect that task without also experiencing near term operational problems due to a near term lack of power reserves.

This process 100 then provides for arranging 103 at least some of the plurality of wireless addresses into an order that represents this at least one item of informational content. Those skilled in the art will recognize and understand that this does not include the trivial case where, for example, the order of the wireless addresses conveys information regarding positions to which the wireless addresses have been assigned or an order in which those wireless addresses are to be processed. Instead, and as but one particular illustrative example in this regard, this can comprise using sequentially presented pairs of wireless addresses to represent a particular bit value as corresponds to the at least one item of informational content.

To illustrate, the plurality of wireless addresses may initially be ordered in a sequential order (running, for example, from the smallest wireless address to the largest wireless address or vice versa). A first sequential order of two sequentially presented wireless addresses (such as, for example, an ascending order) can represent a binary value of zero. Similarly, a second, different sequential order of two sequentially presented wireless addresses (such as, for example, a descending order) can represent a binary value of one.

There are various ways by which such an arrangement can be so achieved. For example, if desired, factorial-based computations can serve such a purpose. As another example, if desired, a hierarchical tree-based approach will serve well in this regard.

As one general example in this regard, when transmitting N addresses, there are N! (or in other words, N factorial or N*(N−1)*(N−2)* . . . *3*2*1) different ways of ordering the N addresses. This is because when creating the address order, there are N possible choices for which address will be first, followed by N−1 possible choices for which address will be second (given the choice of which address was first) and so forth.

For example, if N equals 4, there are 24 ways of ordering the 4 addresses. The choice of ordering can be used to convey 4 bits of information because when there are four bits of information, there are 16 different 4 bit combinations, or 2^{x} (two to the power x). In this example, it is possible to convey the four bits through the ordering of the four addresses because there are more possible orderings for the addresses than there are possible values for these four bits, e.g. 24 is greater than 16.

Another way of saying this is that one can convey x bits through N addresses if N! is greater than or equal to 2^{x}. Yet another way to say this is x is approximately log2(N!). One can use this to determine that, for example, for eight addresses one can convey approximately 15 bits of information. N addresses can be explicitly transmitted and the remaining information then conveyed through the order in which these N addresses are transmitted. This can generally comprise, at the transmitter:

Labeling the list of addresses sorted in ascending order A1 through AN, such that A1 is the smallest address; and

Determining the address ordering corresponding to the value of X to be implicitly transmitted using either:

a lookup table with 2^{x} rows, where each row corresponds to a value of X and a corresponding order in which the 4 addresses should be transmitted; or

Performing the following:
For i=N to 1: Fᵢ=floor (X/(i!)); X=X−Fi*(i!);
For i=1 to N: Insert Ai into position Fᵢ within the addresses transmission order, where the address is inserted into the existing addresses in the leftmost position if Fᵢ=0.
For example: If N=4, and X=13 (or 1101 binary), then F=(1, 0, 2) because X=13=1*1!+0*2!+2*3!=F₁*1!+F₂*2!+F₃*3!=1+2*6.
One can now use F to construct the addresses transmission order as follows: (A1)→(A1, A2)→(A3, A1, A2)→(A3, A1, A4, A2).
In this case, the address construction begins by using A1, (e.g. the smallest of the four addresses address).
At this point, since there is only a single address within the schedule, there are two possible places where A2 can be added. Since the 1^{st} value of the F array is a one and not a zero, the A2 is inserted after A1, e.g (A1)→(A1, A2).
Next, the A3 needs to be inserted into the schedule. Because the second value of the F array is a zero, the A3 is inserted into the leftmost position of the existing schedule. For example, (A1, A2)→(A3, A1, A2).
Next, the A4 needs to be inserted into the schedule. Because the third value of the F array is a 2, the A3 is inserted into the third of the possible positions within the existing schedule. For example, (A3, A1, A2)→(A3, A1, A4, A2). Again, it may be noted that the value of F=0 corresponds to the leftmost possible position for insertion.

Additionally, consider an example where there are 5 addresses, where each address is four bits long and an additional 2 bit field to be transmitted. The approach begins by sorting the list of 5 addresses in ascending order. The transmitter uses the two bit value field to select which of the 5 addresses will be sent implicitly through the ordering of the remaining addresses. For example, if the two bit field is 00 or 0 in decimal, the smallest address is extracted from the list of the five addresses. The approach now simply sets X equal to this extracted/smallest address, and then the example described earlier (for transmitting X through the ordering of four addresses) is used to transmit this value of X through the ordering of the remaining four addresses.

It is actually possible to convey some yet additional information in the case of four addresses. As mentioned above there are 24 different possible orderings for four addresses but there are only 16 different possible values for a four bits. As a result, the system can define additional five bit combinations which correspond to these extra eight possible orderings (8=24−16). In this case, the 5^{th} bit would only be signaled, if the value of X is less than eight. If this 5^{th} bit is zero then X is signaled as described above. However, if this 5^{th} bit is 1, then X+16 is signaled instead of X.

This process 100 then provides for transmitting 104 this shared message, which comprises the plurality of wireless addresses arranged in a manner that corresponds to the order such that the aforementioned informational content is substantively included in the shared message. The mode of transmission can vary greatly with the needs and/or opportunities as correspond to a given application setting. Numerous such possibilities presently exist and others are likely to be developed in the future. As these present teachings are not particularly sensitive to the selection of any particular approach in this regard, for the sake of brevity further elaboration on these points will not be provided here.

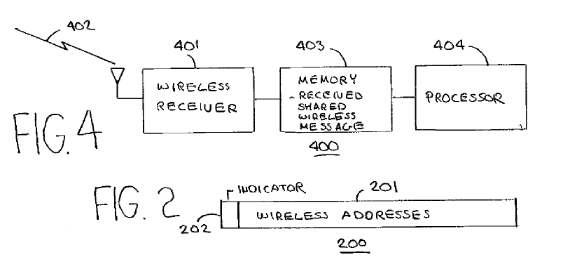

Referring now to FIG. 3, these teachings will also accommodate a process 300 that facilitates the reception and processing of such a shared message. By one illustrative approach, this process 300 can comprise receiving 301, at a given wireless receiver, the shared wireless message that comprises a plurality of wireless addresses that are arranged in a manner that corresponds to a particular order as described above. This process 300 can then provide for decoding 302 the at least one item of informational content as a function, at least in part, of that particular order.

To continue the specific illustrative example provided above, at the receiver one can:

Extract the address order for the four addresses, e.g. (A3, A1, A4, A2).

For the next step one can either use a lookup table with 16 rows, as described above, or one can use the following approach:
Extract Ai from the address schedule in order to determine each value of Fᵢ.
F=(1, 0, 2) because:
   The third value of F is 2, because the A4 was evidently added to the address order in the third possible address position, where the address positions are numbered starting from zero. (A3, A1, A4, A2)→(A3, A1, A2)
   The 2^{nd} value of F is 0, because the A3 was evidently added to the address order in the leftmost possible address position, where the address positions are numbered starting from zero. (A3, A1, A2)→(A1, A2)
   The 1^{st} value of F is 1, because the A2 was evidently added to the address order in the 2^{nd} possible address position, where the address positions are numbered starting from zero. (A1, A2)→(A1)
For i=4 to 1: X=X+Fᵢ*(i!) (where the factorial values can be stored constants if desired); or in other words X=13=1*1!+0*2!+2*3!=F₁*1!+F₂*2!+F₃*3!=1+2*6.
For the example where the value of X is a fifth address, and an additional two bit value is being conveyed:
   two bit field=rank or position of X (the implicitly signaled address) among the explicitly transmitted addresses A1 through A4,

By one approach, as noted above, the shared message may include an indicator to indicate whether a given shared message contains such informational content. This process 300 can therefore optionally provide for determining what this indicator represents for a given received shared message. When this indicator specifies that the shared message does not include such informational content, the wireless receiver can avoid the aforementioned decoding step.

Also if desired, such a decoding step can be avoided unless and until a given wireless receiver first determines that none of the plurality of wireless addresses as are arranged in the manner that corresponds to the particular order in fact correspond to the given wireless receiver itself. This approach can be useful, for example, when the informational content comprises one or more wireless addresses in addition to those that are presented in the particular order. In such a case, when a given wireless receiver can locate its own wireless address in that ordered arrangement, it may not be necessary or useful to also decode that order to extract the additional wireless address (or addresses) that are substantively represented thereby.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 4, an illustrative approach to such a platform as corresponds to the receiver process will now be provided.

In this illustrative embodiment, where the receiver 400 comprises, for example, a cellular telephone, the receiver 400 can comprise a wireless receiver 401 that is configured and arranged to wirelessly receive the aforementioned shared message 402. This wireless receiver 401 operably couples to both a memory 403 and a processor 404. The memory 403 serves, at least in part, to store received shared wireless messages as are described above. The processor 404, in turn, is configured and arranged (via, for example, programming to cause the processor 404 to effect selected teachings as are set forth herein) to decode the informational content as is represented, at least in part, by the particular order of the wireless addresses as comprise received shared messages.

This can comprise, as is noted above, decoding such informational content to thereby extract one or more additional wireless addresses as are substantively conveyed by the order of the plurality of wireless addresses. Once decoded, the receiver 400 can then make such use of such information as is appropriate to a given application setting.

Those skilled in the art will recognize and understand that such an apparatus 400 may be comprised of a plurality of physically distinct elements as is suggested by the illustration shown in FIG. 4. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, additional information, such as but not limited to wireless addresses, can be transmitted using a block of wireless addresses as are to be otherwise conveyed via a shared message to a plurality of corresponding receivers. This, in turn, can often lead to a reduction in the number of transmitted bits as would ordinarily otherwise be required to facilitate the transmission and presentation of such an aggregate quantity of information. The overall savings in system bandwidth can be considerable in application settings where shared messages comprising a plurality of wireless addresses comprise a relatively frequent occurrence. Those skilled in the art will understand and recognize that such teachings are highly scalable and can be employed in conjunction with a wide variety of communication protocols and platforms in a relatively cost effective manner.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one illustrative example in this regard, consider yet another scenario where there can be, for example, a variable number of addresses up to 90 addresses. For example, if explicitly transmitting N*5+M addresses, each with b bits, then in addition, an additional bit field X can be conveyed through the order in which these addresses are transmitted.

At the transmitter:

Partition the bit field X to be transmitted into N subgroups X1, X2, . . . , with the number of bits in each subgroup equal to 6, 14, 18, 20, 22, 24, 25, 26, 27, 27, 28, 29, 29, 30, 30, 31, 31 (If M>0, then X_{Last} contains the last floor (log₂(M)) bits);

Label the sorted list of remaining addresses A1 through AN;

u=1;

For i=0 to N−1: u=(5i+1)*(5i+2)* . . . *(5i+5):
For j=5 to 1
   u=u/(i*5+j)
   F_{i*5+j}=floor (Xj/u); Xj=Xj−F_{i*5+j}*u;
   End
End;

For i=M to 1:
u=(N*5+1)*(N*5+2)* . . . * (N*5+M)
F_{i+5N}=floor (X_{Last}/u); X_{Last}=X_{Last}−F_{i+5N}+*u;
End;

For i=1 to N*5+M: Insert Ai into position Fᵢ within the addresses transmission order. This particular approach seeks to avoid the case where the transmitter must perform multiplication are deficient on a value of X which is more than 32 bits long. It conveys bits through the choice of ordering of addresses in each group of addresses.

We claim:

1. A method comprising:
providing a plurality of wireless addresses to be transmitted using a shared message;
providing at least one item of informational content;
arranging at least some of the plurality of wireless addresses into an order that represents the at least one item of informational content;
transmitting the shared message comprising the plurality of wireless addresses arranged in a manner that corresponds to the order such that the at least one item of informational content is substantively included in the shared message.

2. The method of claim 1 wherein the at least one item of information content comprises at least one of the plurality of wireless addresses.

3. The method of claim 1 wherein arranging at least some of the plurality of wireless addresses into an order that represents the at least one item of informational content comprises, at least in part, using two sequentially presented wireless addresses to represent a particular bit value of the at least one item of informational content.

4. The method of claim 3 wherein:
a first sequential order of the two sequentially presented wireless addresses represents a binary value of zero;
a second sequential order of the two sequentially presented wireless addresses, which second sequential order is different than the first sequential order, represents a binary value of one.

5. The method of claim 1 wherein the shared message further comprises an indicator that the informational content is substantively included in the shared message as conveyed by the order of the plurality of wireless addresses.

6. The method of claim 1 wherein arranging at least some of the plurality of wireless addresses into an order that represents the at least one item of informational content comprises arranging at least some of the plurality of wireless addresses into an order using at least one of:
factorial-based computations;
a hierarchical tree-based approach.

7. The method of claim 1 wherein providing at least one item of informational content comprises selecting the at least one item of informational content as a function, at least in part, of relative resource capacities of wireless platforms to which the wireless addresses correspond.

8. A method comprising:
at a receiver:
receiving a shared wireless message comprising a plurality of wireless addresses arranged in a manner that corresponds to a particular order;
decoding at least one item of informational content as a function, at least in part, of the particular order.

9. The method of claim 8 wherein decoding at least one item of informational content as a function, at least in part, of the particular order occurs when the receiver first determines that none of the plurality of wireless addresses that are arranged in the manner that corresponds to the particular order correspond to the receiver.

10. The method of claim 8 wherein the at least one item of informational content comprises at least one wireless address in addition to the plurality of wireless addresses that are arranged in the manner that corresponds to the particular order.

11. The method of claim 8 wherein decoding at least one item of informational content as a function, at least in part, of the particular order comprises using sequentially presented pairs of wireless addresses to determine corresponding particular bit values of the at least one item of informational content.

12. The method of claim 11 wherein using sequentially presented pairs of wireless addresses to determine corresponding particular bit values of the at least one item of informational content comprises associating:
a first sequential order of a given sequentially presented pair of wireless addresses with a binary value of zero;
a second sequential order of the given sequentially presented pair of wireless addresses, which second sequential order is different than the first sequential order, with a binary value of one.

13. The method of claim 12 wherein the first sequential order comprises an ascending sequential order.

14. The method of claim 8 wherein decoding at least one item of informational content as a function, at least in part, of the particular order occurs in response to recovering an indicator from the shared wireless message that indicates that the informational content is substantively included in the shared wireless message as conveyed by the order of the plurality of wireless addresses.

15. An apparatus comprising:
a wireless receiver;
a memory that is operably coupled to the wireless receiver and having a received shared wireless message comprising a plurality of wireless addresses arranged in a manner that corresponds to a particular order stored therein;
a processor that is operably coupled to the memory and that is configured and arranged to decode at least one item of informational content as a function, at least in part, of the particular order.

16. The apparatus of claim 15 wherein the processor comprises means for decoding the at least one item of informational content as a function, at least in part, of the particular order.

17. The apparatus of claim 15 wherein the at least one item of informational content comprises at least one wireless address in addition to the plurality of wireless addresses that are arranged in the manner that corresponds to the particular order.

18. The apparatus of claim 15 wherein the processor is further configured and arranged to recover an indicator from the shared wireless message that indicates that the informational content is substantively included in the shared wireless message as conveyed by the order of the plurality of wireless addresses.
